(19) United States
(12) Patent Application Publication
(10) Pub. No.: US 2004/0068039 A1
(43) Pub. Date: Apr. 8, 2004

(54) Method of preparing poly(vinyl pivalate)

(76) Inventors: Won-Seok Lyoo, Taeku-city (KR); Han-Do Ghim, Seoul (KR); Jeong-Hyun Yeum, Daeku-city (KR); Chan-Shik park, Seoul (KR); Wong-Jae Yoon, Suwon-city (KR); Tae-Hwan Noh, Suwon-city (KR); Dong-Yoon Shin, Suwon-city (KR)

Correspondence Address: Blakely Sokoloff, Taylor & Zafman, Seventh Floor, 12400 Wilshire Boulevard, Los Angeles, CA, 90025-1026, US

(21) Appl. No.: 10/466,742

(22) PCT Filed: Jan. 17, 2002
(86) PCT No.: PCT/KR02/00081

(30) Foreign Application Priority Data
Jan. 19, 2001 (KR) 20013271

(51) Int. Cl. C08K 3/20

(52) U.S. Cl. 524/459; 526/219.6

(57) ABSTRACT

Poly(vinyl pivalate) exhibiting a high syndiotacticity and a high molecular weight is prepared through suspension polymerization of vinyl pivalate at low temperatures. Furthermore, polyvinyl pivalate) microspheres with a high syndiotacticity is prepared for use as a precursor for PVA with a high molecular weight and a high syndiotacticity through suspension polymerization of vinyl pivalate at 20 to 70 ° C. with the use of azobisdimethylvaleronitrile as an initiator. In addition, polyvinyl pivalate) is separated using a dispersing agent and a predpitating agent to thereby prepare poly(vinyl pivalate) microspheres with various sizes and a uniform size distribution. The poly(vinyl pivalate) microspheres are suspended in an aqueous alkali solution such that only the surface thereof is saponified to PVA. In this way, embolic particles with a spherical shape are obtained to be useable as an embolic B material for embolotherapy.

### BACKGROUND OF THE INVENTION

(a) Field of the Invention

The present invention relates to a method of preparing poly(vinyl pivalate) by low temperature suspension polymerization of vinyl pivalate, and poly(vinyl pivalate) and poly(vinyl alcohol) prepared using the same, and more particularly, to a method of preparing high molecular weight poly(vinyl pivalate) having a particulate or microspherical structure for a precursor of poly(vinyl alcohol) with a high molecular weight and excellent syndiotacticity at a high conversion rate using only a chemical initiator without initiation by ultraviolet rays, through the low temperature suspension polymerization of vinyl pivalate monomer, a method of preparing poly(vinyl pivalate) microspheres, and a method of preparing poly(vinyl alcohol) in the form of precipitate, fiber, and microspherical particulate through the saponification of poly(vinyl pivalate).

(b) Description of the Related Art

Poly(vinyl alcohol) (PVA), which was firstly found by Herrmann and Haehnel of Germany in 1924 (See W. O. Herrmann and W. Haehnel, German Patent No. 450,286, 1924), is a linear semicrystalline hydroxy group-containing polymer prepared through the saponification of vinylester-based polymers such as poly(vinyl acetate). PVA is widely used in plastics, textiles, industrial fibers, and films with respect to the molecular weight thereof. In order for PVA fibers or films to retain a high tensile strength, a high tensile modulus, and a good abrasion resistance, the synthesized PVA should bear a high degree of saponification, a high molecular weight, and an excellent syndiotacticity. For that purpose, it is necessary to use monomers that retain steric hindrance by ester groups such that a high molecular weight syndiotactic precursor can be obtained, or to improve the method of polymerization.

Monomers for synthesizing precursors of, an atactic PVA and a syndiotactic PVA, are widely known. Among them, vinyl pivalate is known to elucidate the best syndiotacticity due to a steric hindrance of tertiary butyl groups thereof, but it cannot be easily saponified. Recently, the present inventor established a method of saponifying poly(vinyl pivalate) (see U.S. Pat. No. 6,124,033). In the past, vinyl trifluoroacetate has been extensively used for monomers for obtaining syndiotactic PVA. Although polymers from such monomers can be saponified in a relatively easy manner compared to that from a vinyl pivalate monomer, the use thereof involves shortcomings of high material cost and poor syndiotacticity.

In order to prepare high molecular weight atactic or syndiotactic PVA that cannot be obtained through the usual PVA polymerization techniques, improvements are needed in the fields of bulk polymerization, solution polymerization, emulsion polymerization, and suspension polymerization.

In bulk polymerization, because only vinyl acetate monomer is used in the polymerization reaction system, the probability of chain transfer is relatively low, and hence, relatively high molecular weight PVA can be obtained. However, the polymerization heat of vinyl acetate is very high, compared to other vinyl-based monomers, and therefore the reaction rate becomes elevated. Consequently, the preparation of high molecular weight PVA cannot be made in an effective manner. Furthermore, the viscosity cannot be controlled easily while making it difficult to obtain a high conversion of over 50%.

In solution polymerization, the viscosity and temperature of polymerization can be easily controlled by way of the solvent used in the polymerization reaction system. Therefore, solution polymerization of vinyl acetate using various solvents such as ethyl acetate, dimethyl carbitol, and acetic acid has been extensively studied. However, branching and termination reactions frequently occur due to the recurrent chain transfer reaction to the solvent so that preparation of high molecular weight PVA cannot be expected. In order to synthesize poly(vinyl acetate) with excellent linearity and prepare a high molecular weight PVA from the linear poly(vinyl acetate), various attempts have been made to conduct redox solution polymerization at low temperatures. However, such a method involves a problem of coloring owing to metal catalysts, and a poor yield.

In emulsion polymerization, it is possible to make a polymerization reaction system that can simultaneously elevate the polymerization degree and the polymerization rate. However, with this system, vinyl acetate involves an extremely high growth reaction rate compared to those of other vinyl-based monomers, as well as branch generation reactions due to the high reaction rate. Consequently, it becomes difficult to obtain a high molecular weight PVA. With emulsion polymerization, several attempts have been made to prepare microspherical PVA particles for embolic applications, but the current situation is such that the particle size does not exceed the minimal size of 100 μm needed for embolic treatment.

In suspension polymerization, a method of preparing high molecular weight PVA at a high conversion rate has been developed. However, as with most of the existent suspension polymerization techniques, the suspension polymerization of vinyl acetate is performed at 50° C. or more. It is necessary to study suspension polymerization of vinyl pivalate at lower temperatures.

PVA is currently used commercially as an embolic material for embolotherapy. Embolotherapy is a medical treatment technology wherein the blood flow in blood supply vessels for lesions at surgically untreatable sites is blocked through injecting a special material into the blood vessels, thereby treating the lesions, relieving symptoms due to an excessive blood flow, and preventing hemorrhaging during surgical operations. Embolotherapy is used to treat hypervascular tumors with high vascularity, vascular diseases such as arteriovenous malformation (AVM), and traumatic or inflammatory hemorrhaging as with tuberculosis.

Markowitz first established the concept of treating diseases by embolotherapy in 1952. He suggested a technique of treating hepatic tumors through blocking arterial blood flow, based on the fact that the liver is supplied with blood via both the hepatic portal vein and the hepatic artery, while the primary and metastatic hepatic tumor cells are mainly supplied via the hepatic artery (See J. Markowitz, Surg. Gynecol. Obstet., 395, 644, 1952).

For selective embolization, it is necessary to confirm whether the hepatic tumor cells are supplied with blood via the hepatic portal vein or the hepatic artery. Hearley and Sheena ascertained through experiments of injecting dyes and radioactive materials that hepatic tumor cells are supplied with blood solely from the hepatic artery (See J. E. Hearley and K. S. Sheena, et al., S Surg. Forum, 14, 121, 1963). Furthermore, Gelin et al. showed that after the removal of the hepatic artery, blood flow in the malignant tumors decreased to 90%, whereas the blood flow in normal tissues decreased by only 35 to 40% (See L. E. Gelin, D. H. Lewis and L. Nilsson, Acta Hepatosplenol, 15, 21, 1968).

Embolotherapy is also used in the treatment of AVM, in addition to liver cancer. It has been reported that embolotherapy to cerebral AVMs results in an increase in survival rate (See L. A. Nisson and L. Zettergen, Acta Pathol. Microbiol. Scand., 71, 187, 1967).

There are various materials that are used as embolic materials. Such materials include metallic coils, liquid tissue adhesives, barium impregnated silastic balls, methacrylates, stainless steels, and particulate materials. Since the 1970s, PVA has been widely used as an embolic material.

First, an ideal embolic material should be made of a substance that exhibits excellent biocompatibility due to the interaction with tissues surrounding the site to be treated. Second, it should effectively get to the target site of lesions to achieve an excellent therapeutic effect and to predict therapeutic effects. Third, the ideal embolic material should be easily handled and injected for general clinical use. Fourth, the ideal embolic material should exhibit permanent embolic effects while bearing a uniform distribution of particle sizes. Finally, it should form a homogeneous suspension in a nonionic vehicle. In consideration of such requirements, it can be easily understood that the ideal embolic material should bear a uniform size distribution of particles with a microspherical shape.

PVA has been highlighted as an embolic material because of its biocompatibility, technical ease, and capability of fluent adjustment in particle size. At present, PVA is used as an embolic material for malignant hepatic tumors, hepatic AVMs, cerebral AVMs, and vascular tumors in many sites, etc. As PVA is the most widely used among currently existing embolic materials, extensive studies related thereto are in progress.

However, it is reported that the use of PVA both in existing studies and in clinics has caused side effects such as inflammation of the embolized blood vessel. This inflammation is assumed to be caused by the sharp-edged portions of the materials used. Moreover, it is reported that neonates have died after the treatment of their AVMs with commercial embolic PVA. This has led to studies on the uniformity in size of commercial embolic PVA particles, and study results show that the death of neonates is related to the non-uniformity of the particle sizes (See I. Repa, et al., Radiology, 170, 395, 1989).

The currently available commercial embolic PVA products such as Contour®, Embosphere®, and Ultra Drivalon® have a very low uniformity of particle sizes. It is reported that the particle sizes in such products are non-uniformly distributed over the wide range of 1 to 1400 μm or more. Furthermore, the commercial PVA embolic material “Contour®” has a very rough and sharp surface while being significantly differentiated from spherical particles with a uniform size distribution.

In order to develop ideal microspherical embolic materials, up until now, many researchers have made attempts to prepare spherical particles from various polymers other than PVA, such as porous cellulose, gelatin, collagen and collagen-coated acryl polymer. However, as natural polymeric materials such as gelatin are obtained directly from nature, it is impossible to control the molecular parameters (e.g. molecular weight, molecular weight distribution, and degree of branching) and physical dimensions (particle size and shape) of the natural polymeric materials. Additionally, it is difficult to make spherical particles of variable sizes appropriate to each disease and of uniform size distribution in view of surgical cases. Furthermore, the permanent embolic effects of such embolic materials have not yet been confirmed.

A uniform particle size distribution is necessary for the embolic materials to be fed to the target area through a catheter during a surgical operation as well as to enhance the therapeutic effects of embolotherapy through selective occluding of blood vessels. Although the polymeric particles prepared by suspension polymerization are generally retained in spherical forms, their sizes are very different with respect to the conditions of polymerization. Furthermore, it is very difficult to separate them into individual uniform sized particles because they associate due to static attractive forces between the suspending agents used during polymerization and the polymeric particles.

The same problems occur when poly(vinyl pivalate) is prepared by means of suspension polymerization of vinyl pivalate. When poly(vinyl pivalate) is saponified to PVA, the PVA particles are retained in spherical forms but their sizes are non-uniform. With the associated particles, it becomes difficult to inject them into the required position and to facilitate high selectivity occluding of the blood vessels around injuries. Therefore, in order to prepare PVA particles as an excellent high quality embolic material, it is necessary to separate poly(vinyl pivalate) microspheres for a precursor.

It is also important in the pigment and dye industries to associate and separate microspherical particles in a suitable manner. This is particularly true in the case of dye, as it is not hydrophilic, and it involves associated and crystallized large particles due to its molecular structure. When dyes are applied to target objects, the dye particle size is a critical factor for enhancing the color properties and the transparency of the objects. For this reason, a dispersing agent is added to the dye precursor to prevent association of the particles while controlling the particles sizes through milling. In order to prevent association of hydrophobic dye particles, a hydrophilic and hydrophobic organic dispersing agent is introduced during the process of milling. However, such a dispersing agent is mainly based on aromatic organic materials so it is difficult to remove the agent through washing. Accordingly, it is impossible to apply the resulting dye products for use in a living body.

The PVA embolic materials are prepared through saponifying poly(vinyl pivalate). The saponification of poly(vinyl pivalate) is achieved by completely dissolving poly(vinyl pivalate) in an organic solvent such as tetrahydrofuran, acetone and methyl ethyl ketone, and adding the alkali solution in a dropwise manner. The resulting PVA materials have a very irregular surface, various shapes ranging from a precipitation phase to a fibrous phase, and a very wide size distribution. Accordingly, in order to produce embolic particulate materials with excellent embolic ability, a new saponification method that can prohibit the association of particles while maintaining the particle shape in a stable manner is needed.

### SUMMARY OF THE INVENTION

It is an object of the present invention to provide a method of preparing high molecular weight poly(vinyl pivalate) through low temperature suspension polymerization while using only a chemical initiator without initiation by ultraviolet rays.

It is an another object of the present invention to provide a method of preparing high molecular weight poly(vinyl pivalate) microspheres of various sizes distributed in a uniform manner.

It is still another object of the present invention to provide PVA in the form of precipitate, fiber, and microsphere exhibiting a high molecular weight, a high syndiotacticity, and a uniform size distribution which can be prepared at a low cost but at a high yield.

It is still another object of the present invention to provide microspherical embolic particles having a dual structure of a PVA skin and a poly(vinyl pivalate) core where the surface of the poly(vinyl pivalate) is saponified while maintaining its microspherical shape without deformation.

Additional objects and advantages of the invention will be set forth in part in the description which follows and, in part, will be obvious from the description, or may be learned by practice of the invention.

In the method according to one aspect of the present invention, poly(vinyl pivalate) is prepared through suspension polymerization of vinyl pivalate where a suspension including vinyl pivalate, azobisdimethylvaleronitrile as an initiator, a suspending agent and water is stirred at 20 to 70° C. with a stirring speed of 10 to 5000 rpm. The suspension has a composition of per 1 mol of the vinyl pivalate 1×10⁻⁵ mol to 5×10⁻⁴ mol of the initiator, 1×10⁻⁶ mol to 1×10⁻⁴ mol of the suspending agent, and 1.0 mol to 50 mol of water.

Consequently, high molecular weight syndiotactic poly(vinyl pivalate) is obtained with the characteristics of a conversion rate from monomer to polymer of 50% or more, a number-average degree of polymerization of 300 to 50,000, a syndiotactic diad content of 54 to 65%, and a degree of branching of 0.2 to 6.0 with respect to the pivalate group.

Furthermore, PVA in the form of precipitate, fiber, or microsphere with high syndiotacticity, a high molecular weight, and a number-average degree of polymerization of 200 to 20,000 can be obtained using the poly(vinyl pivalate).

In the method according to the another aspect of the present invention, poly(vinyl pivalate) microspheres are prepared through adding inorganic salt as a dispersing and antistatic agent to poly(vinyl pivalate) microspheres, milling the associated poly(vinyl pivalate) microspheres, and separating the poly(vinyl pivalate) microspheres using standard sieves to obtain the uniform sized poly(vinyl pivalate) microspheres. The resultant microspherical poly(vinyl pivalate) microspheres have uniform particle diameters ranging from 1 μm to 3000 μm, where a difference between upper and lower limits of the particle diameters ranges from about 1 μm to about 500 μm, and a polydispersity index of particle diameter ranges from 1.00 to 1.60.

In the method according to still another aspect of the present invention, embolic particles having a dual structure of an outer PVA skin and an inner poly(vinyl pivalate) core are prepared through suspending microspherical poly(vinyl pivalate) microspheres in an aqueous alkali solution including at least one salt selected from the group consisting of sulfates, sulfites, and mixtures thereof; hydroxides; alcohols for an inflating agent; and water, such that the surface of the poly(vinyl pivalate) microspheres is saponified.

The embolic particles have a degree of saponification of 1 to 99.9%, and a polydispersity index of particle diameter of 1.00 to 1.20.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawings, wherein:

FIG. 1 is a scanning electronic microscopic (SEM) photograph of PVA embolic particles according to Example of the present invention; and

FIG. 2 is a SEM photograph of PVA prepared by conventional homogeneous saponification of poly(vinyl pivalate) according to Comparative Example.

### DETAILED DESCRIPTION OF THE PREFERRED EMBODIMENTS

Preferred embodiments of this invention will be explained with reference to the accompanying drawings.

The process of preparing high molecular weight syndiotactic poly(vinyl pivalate) according to the present invention differs largely from the conventional poly(vinyl pivalate) preparation process.

First, the conventional poly(vinyl pivalate) preparation process involves the use of ultraviolet rays or gamma rays because the monomers are initiated at low temperatures. This process involves complicated processing steps while requiring high-cost polymerization equipment.

Second, in the conventional poly(vinyl pivalate) preparation process, poly(vinyl pivalate) is synthesized using azobisisobutylonitrile or benzoyl peroxide at the polymerization temperature range of 50 to 70° C., which is the temperature range of initiation in usual addition polymerization. As the polymerization is performed at relatively high temperatures, the molecular weight of the resulting poly(vinyl pivalate) becomes lowered compared to that of poly(vinyl pivalate) prepared by the usual light illumination polymerization at low temperatures. Third, in high temperature bulk polymerization, the polymerization rate is elevated due to the high polymerization temperatures so that it becomes difficult to obtain a high molecular weight, while the conversion rate is lowered. In the case of bulk polymerization, it is difficult to obtain a conversion rate of 80% or more when low temperature polymerization is is undertaken to obtain high molecular weight poly(vinyl pivalate) with high syndiotacticity. Emulsion polymerization also involves problems related to bulk polymerization. In the case of solution polymerization, the conversion rate can be highly elevated through increasing the amount of polymerizing solvent, but this seriously effects a chain transfer reaction to the solvent, resulting in a lowered molecular weight of the poly(vinyl pivalate).

Furthermore, with the conventional poly(vinyl pivalate) preparation process, it is impossible to obtain uniform sizes of poly(vinyl pivalate) microspheres, and to make relatively large-sized particles for the embolotherapy. It is necessary for the respective surgical cases of embolotherapy to use the embolic particles having diameters of 100 μm, 200 μm, 300 μm, 400 μm, 500 μm, 600 μm, 800 μm, and 1000 μm.

In order to overcome such problems, with the inventive poly(vinyl pivalate) preparation process, poly(vinyl pivalate) microspheres having a high number-average degree of polymerization, various particle sizes, and uniform size distributions are prepared at a high conversion rate through suspension polymerization of vinyl pivalate at 20 to 70° C., and preferably 20 to 50° C., while using azobisdimethylvaleronitrile as an initiator.

In a poly(vinyl pivalate) preparation method according to a first preferred embodiment of the present invention, the suspension polymerization of vinyl pivalate is performed at 20 to 70° C. with the stirring speed of 10 to 5000 rpm under the condition, wherein, the amount of azobisdimethylvaleronitrile initiator is established to be 1×10⁻⁵ mol to 5×10⁻³ mol, the amount of suspending agent is established to be 1×10⁻⁵ mol to 5×10⁻³ mol, and the amount of water is established to be 0.1 mol to 50 mol per 1 mol of vinyl pivalate.

With suspension polymerization, an initiator and a suspending agent capable of being dissolved in monomers are used, and this makes it easy to separate microspherical polymer particles from the polymerization reaction system. Furthermore, as the polymerization mechanism for the respective suspended particles is basically the same as in the case of bulk polymerization, high molecular weight poly(vinyl pivalate) exhibiting excellent linearity for preparing high molecular weight PVA can be prepared in an effective manner. That is, ultrahigh molecular weight poly(vinyl pivalate) with high syndiotacticity being well adapted for use as a precursor of PVA with a high molecular weight and a high syndiotacticity can be prepared through the suspension polymerization of vinyl pivalate.

Suspension polymerization is performed through mixing and stirring water and a suspending agent in a mixer equipped with a thermometer, a nitrogen inlet, a cooling column, and an anchor-type stirrer at 30 to 70° C., and cooling the mixture at ambient temperature. Nitrogen, which passes a trap of pyrogallol-alkali solution and a trap of CaCl₂ to remove its oxygen and moisture content, is forcefully passed through the mixture to thereby remove the oxygen and moisture content from the mixture. Vinyl pivalate monomer and azobisdimethylvaleronitrile initiator are added to the mixture, and the temperature in the mixer is elevated to 20 to 70° C. Thereafter, the polymerization of vinyl pivalate is preformed under the nitrogen stream.

The azobisdimethylvaleronitrile initiator may induce the polymerization reaction at the relatively low temperature of 50° C. or less due to its structural characteristics, compared to the usual addition polymerization initiators, such as azobisisobutylonitrile and benzoyl peroxide.

The suspending agent may be at least one selected from PVA, arabic gum, hydroxyethyl cellulose, methyl cellulose, starch, sodium polyacrylate, sodium polymethacrylate, gelatine, or styrene-maleic anhydride copolymer neutralized with sodium hydroxide or aqueous ammonia, but It is not limited thereto. It is most preferable to use partially or completely saponified PVA as the suspending agent.

As described above, high molecular weight poly(vinyl pivalate) microspheres with various particle sizes and a uniform size distribution can be prepared through controlling the amount of initiator, suspending agent, and water while regulating the polymerization temperature and the stirring speed. In the case the above-described suspension polymerization conditions are not satisfied, it is difficult to obtain high molecular weight poly(vinyl pivalate) with a uniform size distribution. The bottommost values of the polymerization conditions are the minimal values of occurrence of polymerization. For instance, the bottommost value of concentration in the initiator is established to be 1×10⁻⁵ mol per 1 mol of vinyl pivalate. In the case the concentration of the initiator is lower than the value, polymerization at the relevant temperature does not occur.

The molecular weight of poly(vinyl pivalate) is controlled through varying the concentration of the initiator and the polymerization temperature. The greater the stirring speed is, the more particle shapes become uniform, and the molecular weight and the conversion rate are increased.

The poly(vinyl pivalate) prepared using the method according to the first preferred embodiment invention bears a conversion rate from monomer to polymer of 50% or more, a number-average degree of polymerization of 300 to 50,000, a syndiotactic diad content of 54 to 65%, and a degree of branching of 0.2 to 6.0 with respect to the pivalate group.

The poly(vinyl pivalate) may have various sizes of microspherical particles ranged from 1 μm to 3000 μm, for instance, 1 μm, 5 μm, 10 μm, 50 Man, 100 μm, 200 μm, 300 μm, 400 μm, 500 μm, 600 μm, 800 μm, 1000 μm, 1500 μm, 2000 μm, and 3000 μm. The particle sizes of poly(vinyl pivalate) microspheres prepared during one process can be controlled to be uniformly distributed.

Furthermore, high molecular weight PVA in the form of precipitate, fibrous or microspherical shapes with a high syndiotacticity and a number-average degree of polymerization of 200 to 20000 can be prepared using the poly(vinyl pivalate) prepared through the method according to the first preferred embodiment.

Furthermore, the poly(vinyl pivalate) may be used as a precursor for preparing microspherical PVA embolic particles.

PVA is prepared through the saponification of poly(vinyl pivalate). The process of separating poly(vinyl pivalate) microspheres is a critical factor in obtaining PVA with a uniform particle size distribution.

In the polymeric particles prepared by conventional suspension polymerization, the associations occur because of the electrostatic attraction between the suspending agents and the particles, and because of the electrostatic attraction among the particles themselves. Although the associated particles are separated through milling, the particles are re-associated due to the electrostatic charge of the particles. Therefore, it is very difficult to separate the particles to a uniform size. Particularly, the electrostatic charge makes it difficult to perform the subsequent saponification process in a precise and stable manner while arising many problems such as adhesion of the particles to the reactor wall.

In a poly(vinyl pivalate) preparation method according to a second preferred embodiment of the present invention, the poly(vinyl pivalate) microspheres with uniform size distributions are separated from the various sized poly(vinyl pivalate) microspheres using inorganic salt as a dispersing and antistatic agent during the milling process, thereby preventing the breakage of the microspheres due to the milling and removing the electrostatic charge of the microspherical particles while making the subsequent processing steps easier and blocking re-association of the microspherical particles.

In the poly(vinyl pivalate) preparation method, inorganic salt is added to the poly(vinyl pivalate) microspheres prepared through the suspension polymerization as a dispersing and antistatic agent, and the associated poly(vinyl pivalate) microspheres are milled and separated using standard sieves. The resulting poly(vinyl pivalate) microspheres have uniform particle diameters ranging from 1 μm to 3000 μm, where a difference between upper and lower limits of the particle diameters ranges from about 1 μm to about 500 μm, and a polydispersity index of particle diameter ranging from 1.00 to 1.60.

The inorganic salt for the dispersing and antistatic agent is preferably at least one selected from alkali metal salts, alkali earth metal salts, or mixtures thereof. For instance, sodium sulfate (Na₂SO₄), sodium sulfite (Na₂SO₃), sodium chloride (NaCl), calcium sulfate (CaSO₄), or magnesium sulfate (MgSO₄) may be used for these purposes.

It is preferable that the inorganic salt for the dispersing and antistatic agent is added to the poly(vinyl pivalate) microspheres in the amount of 0.1 g to 100 g per 1 g of the poly(vinyl pivalate) microspheres. In the case the amount of inorganic salt is less than 0.1 g, the desired antistatic effect cannot be obtained. By contrast, in case that the amount of inorganic salt exceeds 100 g, the desired milling process cannot be achieved.

The inorganic salt for the dispersing and antistatic agent prevents association of particles within the reaction solution during the subsequent saponification process, and it is ultimately removed through washing. Therefore, it does not cause any problems to the PVA particles for embolic materials, while being differentiated from the conventional organic dispersing agent.

In the preparation of poly(vinyl pivalate) microspheres using the method according to the second preferred embodiment, the particle diameters range from 1 μm to 3000 μm, where a difference between upper and lower limits of the particle diameters ranges about 1 μm to about 500 μm, and the polydispersity of particle diameter ranges from 1.00 to 1.60. The smaller the particle sizes are, the more the difference between the upper and lower limits of the particle diameters is reduced, down to several micrometers, while making it possible to control the particle diameter in a precise manner. The poly(vinyl pivalate) microspheres have similar particle sizes and size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400-450 μm, 450-500 μm, 500-600 μm, 600-700 μm, 700-800 μm, 800-900 μm, 900-1000 μm, 1000-1200 μm, 1200-1500 μm, 1500-1800 μm, 1800-2000 μm, 2000-2300 μm, or 2500-3000 μm.

In a method of preparing a PVA embolic material according to a third preferred embodiment of the present invention, the poly(vinyl pivalate) microspheres prepared using the method according to the second preferred embodiment are saponified such that the particles are maintained in their spherical shapes without deformation while having a dual structure of a PVA skin and a poly(vinyl pivalate) core where only the surface of the poly(vinyl pivalate) is saponified.

The embolic particles have an outer PVA skin and an inner poly(vinyl pivalate) core while bearing sizes available for use in embolotherapy, with a uniform size distribution. The new method of preparing such embolic particles has several specific characteristics.

In the conventional homogeneous saponification process, the conversion of the poly(vinyl pivalate) into PVA is carried out through dissolving poly(vinyl pivalate) in an organic solvent such as tetrahydrofuran, acetone, or methyl ethyl ketone while using a high concentration of aqueous alkali solution as a catalyst. The resulting PVA particles, however, have irregular sizes and rough surfaces so that, upon use as embolic materials, the desired high selectivity occlusions of the blood vessels cannot be achieved, and they cause inflammation to the vascular wall.

To resolve such problems, with the inventive process, the poly(vinyl pivalate) microspheres prepared through suspension polymerization are suspended in an aqueous alkali solution so as to induce the inhomogeneous surface saponification, thereby maintaining a completely spherical shape and smooth surface of the microspheres.

The aqueous alkali solution includes at least one salt selected from the group consisting of sulfates, sulfites, and mixtures thereof; hydroxides; alcohols for an inflating agent; and water.

For instance, sodium sulfate may be used for the sulfate salt, and sodium sulfite may be used for the sulfite salt. Alkali metal hydroxides may be used for the hydroxide, and among them, sodium hydroxide and potassium hydroxide are preferably used for that purpose. Methanol and ethanol or mixtures thereof may be preferably used for the alcohols for an inflating agent.

The respective amount of the salts, and the hydroxides is preferably established to be 0.1 to 100 g per 1 g of the poly(vinyl pivalate) microspheres. The amount of alcohols for an inflating agent is established to be 0.1 to 100 g per 1 g of the poly(vinyl pivalate) microspheres. The amount of the aqueous alkali solution is established to be 10 to 1000 ml per 1 g of the poly(vinyl pivalate) microspheres.

It is preferable that the inhomogeneous surface saponification reaction of the poly(vinyl pivalate) microspheres is performed at 0 to 150° C. The poly(vinyl pivalate) microspheres are prepared as the particulate embolic material with an inner poly(vinyl pivalate) core and an outer PVA skin through the surface saponification.

In the particulate embolic material prepared using the method according to the third preferred embodiment, the polydispersity index of particle diameter is established to be 1.00 to 1.20, and the saponification degree of the poly(vinyl pivalate) is established to be 1 to 99.9%. It is preferable that the ratio of the outer diameter of PVA to the inner diameter of the poly(vinyl pivalate) microspheres is established to be 1:0.01 to 0.99.

As the poly(vinyl pivalate) microspherical particles retain their spherical shape without deformation, the particle diameters uniformly range from 1 μm to 3000 μm, where the difference between upper and lower limits of the particle diameters ranges about 1 μm to about 500 μm. This makes it possible to effectively use such embolic particles in embolotherapy. The embolic particles have nearly similar particle sizes and size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400-450 μm, 450-500 μm, 500-600 μm, 600-700 μm, 700-800 μm, 800-900 μm, 900-1000 μm, 1000-1200 μm, 1200-1500 μm, 1500-1800 μm, 1800-2000 μm, 2000-2300 μm, or 2500-3000 μm.

Furthermore, it is possible to impart the particles with characteristics such as a specific particle density, and with a functionality such as surface modifications to facilitate the formation of thrombi, iodine-complex forming capability, and the like, by varying the reaction conditions, for instance, by controlling the amount of PVA. The specific and comparative examples will now be illustrated. However, the examples are presented only for illustrative purposes, and should not be construed as limiting the invention.

### EXAMPLE 1

In a 200 ml four-neck flask equipped with a thermometer, a nitrogen inlet, a cooling column, and an anchor-type stirrer, 60 ml (3.3 mol) of distilled water and 0.9 g of PVA (7.09×10⁻⁶ mol, degree of saponification of 88%, and number-average molecular weight of 127,000) for a suspending agent were charged, mixed at 50° C., and cooled at ambient temperature. Nitrogen, which passed a trap of pyrogallol-alkali solution and a trap of CaCl₂ to remove its oxygen and moisture content, was forcefully passed through the mixture for two hours to thereby remove the oxygen and moisture content from the mixture. 44.1 ml (0.3 mol) of vinyl pivalate monomer and 0.0166 g (2×10⁻⁴ mol/mol of monomer) of azobisdimethylvaleronitrile initiator were added to the mixture, and the oxygen and moisture content were removed from the mixture for one hour. The temperature in the flask was elevated to 50° C., and the vinyl pivalate monomer was polymerized through stirring at 300 rpm under the nitrogen stream for 24 hours. Chilled distilled water was poured into the suspension including polymer to precipitate polymer particle from suspension, and its was filtered with a glass filter. The residue underwent washing and filtration several times while removing the remaining monomers and suspending agent. The residue was dried at 40° C. under a vacuum atmosphere for one day, thereby obtaining white poly(vinyl pivalate) microspheres.

### EXAMPLE 2

Other conditions were established to be the same as those related to Example 1 except that the amount of azobisdimethylvaleronitrile initiator was 0.0083 g (1×10⁻⁴ mol/mol of monomer).

### EXAMPLE 3

Other conditions were established to be the same as those related to Example 1 except that the amount of azobisdimethylvaleronitrile initiator was 0.0025 g (3×1-5 mol/mol of monomer).

### EXAMPLE 4

Other conditions were established to be the same as those related to Example 1 except that the amount of azobisdimethylvaleronitrile initiator was 0.0017 g (2×¹⁰⁻⁵ mol/mol of monomer).

### EXAMPLE 5

Other conditions were established to be the same as those related to Example 1 except that the amount of azobisdimethylvaleronitrile initiator was 0.0008 g (1×10⁻⁵ mol/mol of monomer).

### EXAMPLE 6

Other conditions were established to be the same as those related to Example 1 except that the polymerization was performed at 40° C. for 36 hours.

### EXAMPLE 7

Other conditions were established to be the same as those related to Example 6 except that the amount of azobisdimethylvaleronitrile initiator was 0.0083 g (1×10⁻⁴ mol/mol of monomer).

### EXAMPLE 8

Other conditions were established to be the same as those related to Example 6 except that the amount of azobisdimethylvaleronitrile initiator was 0.0025 g (3×10⁻⁵ mol/mol of monomer).

### EXAMPLE 9

Other conditions were established to be the same as those related to Example 1 except that the polymerization was performed at 30° C. for 52 hours.

### EXAMPLE 10

Other conditions were established to be the same as those related to Example 9 except that the amount of azobisdimethylvaleronitrile initiator was 0.0083 g (1×10⁻⁴ mol/mol of monomer).

### EXAMPLE 11

Other conditions were established to be the same as those related to Example 9 except that the amount of azobisdimethylvaleronitrile initiator was 0.0025 g (3×10⁻⁵ mol/mol of monomer).

### EXAMPLE 12

Other conditions were established to be the same as those related to Example 1 except that the amount of PVA for the suspending agent was

2.7 g (2.13×10⁻⁵ mol, degree of saponification of 88%, and number-average molecular weight of 127,000).

### EXAMPLE 13

Other conditions were established to be the same as those related to Example 12 except that the amount of azobisdimethylvaleronitrile initiator was 0.0025 g (3×10⁻⁵ mol/mol of monomer).

### EXAMPLE 14

Other conditions were established to be the same as those related to Example 12 except that the amount of azobisdimethylvaleronitrile initiator was 0.0008 g (1×10⁻⁵ mol/mol of monomer).

### EXAMPLE 15

Other conditions were established to be the same as those related to Example 6 except that the amount of PVA for the suspending agent was 2.7 g (2.13×10⁻⁵ mol, degree of saponification of 88%, and number-average molecular weight of 127,000).

### EXAMPLE 16

Other conditions were established to be the same as those related to Example 15 except that the amount of azobisdimethylvaleronitrile initiator was 0.0025 g (3×10⁻⁵ mol/mol of monomer).

### EXAMPLE 17

Other conditions were established to be the same as those related to Example 9 except that the amount of PVA for the suspending agent was 2.7 g (2.13×10⁻⁵ mol, degree of saponification of 880%, and number-average molecular weight of 127,000).

### EXAMPLE 18

Other conditions were established to be the same as those related to Example 17 except that the amount of azobisdimethylvaleronitrile initiator was 0.0025 g (3×10⁻⁵ mol/mol of monomer).

### EXAMPLE 19

Other conditions were established to be the same as those related to Example 1 except that the amount of PVA for the suspending agent was 0.3 g (2.36×10⁻⁶ mol, degree of saponification of 88%, and number-average molecular weight of 127,000).

### EXAMPLE 20

Other conditions were established to be the same as those related to Example 19 except that the amount of azobisdimethylvaleronitrile initiator was 0.0025 g (3×10⁻⁵ mol/mol of monomer).

### EXAMPLE 21

Other conditions were established to be the same as those related to Example 19 except that the amount of azobisdimethylvaleronitrile initiator was 0.0008 g (1×10⁻⁵ mol/mol of monomer).

### EXAMPLE 22

Other conditions were established to be the same as those related to Example 6 except that the amount of PVA for the suspending agent was 0.3 g (2.36×10⁻⁶ mol, degree of saponification of 88%, and number-average molecular weight of 127,000).

### EXAMPLE 23

Other conditions were established to be the same as those related to Example 22 except that the amount of azobisdimethylvaleronitrile initiator was 0.0025 g (3×10⁻⁵ mol/mol of monomer).

### EXAMPLE 24

Other conditions were established to be the same as those related to Example 9 except that the amount of PVA for the suspending agent was 0.3 g (2.36×10⁻⁴ mol, degree of saponification of 88%, and number-average molecular weight of 127,000).

### EXAMPLE 25

Other conditions were established to be the same as those related to Example 24 except that the amount of azobisdimethylvaleronitrile initiator was 0.0025 g (3×10⁻⁵ mol/mol of monomer).

### EXAMPLE 26

Other conditions were established to be the same as those related to Example 11 except that the polymerization was performed while stirring at 100 rpm.

### EXAMPLE 27

Other conditions were established to be the same as those related to Example 11 except that the polymerization was performed while stirring at 500 rpm.

### EXAMPLE 28

Other conditions were established to be the same as those related to Example 11 except that the polymerization was performed while stirring at 1000 rpm.

### EXAMPLE 29

Other conditions were established to be the same as those related to Example 11 except that the polymerization was performed while stirring at 2000 rpm.

### EXAMPLE 30

Other conditions were established to be the same as those related to Example 11 except that the polymerization was performed while stirring at 3000 rpm.

### EXAMPLE 31

Other conditions were established to be the same as those related to Example 11 except that the polymerization was performed at 25° C. for 60 hours while stirring at 2000 rpm.

### EXAMPLE 32

Other conditions were established to be the same as those related to Example 1 except that the polymerization was performed for 12 hours.

### EXAMPLE 33

Other conditions were established to be the same as those related to Example 1 except that the polymerization was performed for 18 hours.

### EXAMPLE 34

The poly(vinyl pivalate) microspheres of (particle diameter of 50 to 1000 μm, polydispersity index of particle diameter of 1.80, number-average degree of polymerization of 40,000, and degree of branching of 2.3) prepared by suspension polymerization as in Example 3 were milled with a mortar and pestle using sodium chloride as a dispersing and antistatic agent in an amount of 0.5 g per 1.0 g of the poly(vinyl pivalate) microspheres, and separated using standard sieves. The separated microspheres were stirred with a magnetic stirrer in a 250 ml beaker, washed with 100 ml of distilled water for 4 hours, and filtered with a glass filter. After the residue was dried at 40° C. under a vacuum atmosphere for one day, microspheres bearing various sizes were obtained. The separated microspheres had size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400-450 μm, 450-500 μm, 500-600 μm, 600-700 μm, 700-800 μmm. 800-900 μm, 900-1000 μm, 1000-1200 μm, 1200-1500 μm, 1500-1800 μm, 1800-2000 μm, 2000-2300 μm and 2500-3000 μm, and a polydispersity index of 1.03 to 1.06.

The “polydispersity index of particle diameter” is defined as the value obtained by dividing a weight average particle diameter with a number-average particle diameter for 500 microspheres. In the case the polydispersity index of the particle diameter is in the range of 1.0 to 1.2, it is known that these microspheres may be referred to as monodisperse or nearly monodisperse.

### EXAMPLE 35

The poly(vinyl pivalate) microspheres of (particle diameter of 50 to 1000 to, polydispersity index of particle diameter of 1.80, number-average degree of polymerization of 40,000, and degree of branching of 2.3) prepared by suspension polymerization as in Example 3 were milled with a mortar and pestle using magnesium sulfate as a dispersing and antistatic agent in an amount of 0.5 g per 1.0 g of the poly(vinyl pivalate) microspheres, and separated using standard sieves. The separated microspheres were stirred with a magnetic stirrer in a 250 ml beaker, washed with 100 ml of distilled water for 4 hours, and filtered with a glass filter. After the residue was dried at 40° C. under a vacuum atmosphere for one day, microspheres bearing various sizes were obtained. The separated microspheres had size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400-450 μm, 450-500 μm, 500-600 μm, 600-700 μm, 700-800 μm, 800 μm, 900-1000 μm, 1000-1200 μm, 1200-1500 μm, 1500-1800 μm, 1800-2000 μm, 2000-2300 μm, and a polydispersity index of 1.03 to 1.08.

### EXAMPLE 36

The poly(vinyl pivalate) microspheres of (particle diameter of 50 to 1000 μm, polydispersity index of particle diameter of 1.80, number-average degree of polymerization of 40,000, and degree of branching of 2.3) prepared by suspension polymerization as in Example 3 were milled with a mortar and pestle using calcium sulfate as a dispersing and antistatic agent in an amount of 0.5 g per 1.0 g of the poly(vinyl pivalate) microspheres, and separated using standard sieves. The separated microspheres were stirred with a magnetic stirrer in a 250 ml beaker, washed with 100 ml of distilled water for 4 hours, and filtered with a glass filter. After the residue was dried at 40° C. under a vacuum atmosphere for one day, microspheres bearing various sizes were obtained. The separated microspheres had size distributions of 1-5 μm, 5-10 μm, 10-30 μm, 30-50 μm, 50-70 μm, 70-90 μm, 90 μm, 100-120 μm, 120-150 μm, 150-180 μm, 180-200 μm, 200-220 μm, 220 μm, 250-300 μm, 300-350 μm, 350-400 μm, 400-450 μm, 450-500 μm, 500-600 μm, 600-700 μm, 700-800 μm, 800-900 μm, 900-1000 μm, 1000-1200 μm, 1200-1500 μm, 1500-1800 μm, 1800-2000 μm, 2000-2300 μm, and a polydispersity index of 1.04 to 1.09.

### EXAMPLE 37

The Poly(vinyl pivalate) microspheres of (particle diameter of 50 to 1000 μm, polydispersity index of particle diameter of 1.80, number-average degree of polymerization of 40,000, and degree of branching of 2.3) prepared by suspension polymerization as in Example 3 were milled with a mortar and pestle using sodium sulfate as a dispersing and antistatic agent in an amount of 0.5 g per 1.0 g of the poly(vinyl pivalate) microspheres, and separated using standard sieves. The separated microspheres were stirred with a magnetic stirrer in a 250 ml beaker, washed with 100 ml of distilled water for 4 hours, and filtered with a glass filter. After the residue was dried at 40° C. under a vacuum atmosphere for one day, microspheres bearing various sizes were obtained. The separated microspheres had size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220 μm, 250-300 μm, 300-350 μm, 350-400 μm, 400-450 μm, 450-500 μm, 500-600 μm, 600-700 μm, 700-800 μm, 800-900 μm, 900-1000 μm, 1000-1200 μm, 1200-1500 μm, 1500-1800 μm, 1800-2000 μm, 2000-2300 μm and 2500 μm, and a polydispersity index of 1.02 to 1.08.

### EXAMPLE 38

The poly(vinyl pivalate) microspheres of (particle diameter of 50 to 1000 μm, polydispersity index of particle diameter of 1.80, number-average degree of polymerization of 40,000, and degree of branching of 2.3) prepared by suspension polymerization as in Example 3 were milled with a mortar and pestle using sodium sulfite as a dispersing and antistatic agent in an amount of 0.5 g per 1.0 g of the poly(vinyl pivalate) microspheres, and separated using standard sieves. The separated microspheres were stirred with a magnetic stirrer in a 250 ml beaker, washed with 100 ml of distilled water for 4 hours, and filtered with a glass filter. After the residue was dried at 40° C. under a vacuum atmosphere for one day, microspheres bearing various sizes were obtained. The separated microspheres had size distributions of 1-5 μm, 5-10 μm, 10-30 μm, 30-50 μm, 50-70 μm, 70-90 μm, 90 μm, 100-120 μm, 120-150 μm, 150-180 μm, 180-200 μm, 200-220 μm, 220 μm, 250-300 μm, 300-350 μm, 350-400 μm, 400-450 μm, 450-500 μm, 500-600 μm, 600-700 μm, 700-800 μm, 800-900 μm, 900-1000 μm, 1000-1200 μm, 1200-1500 μm, 1500-1800 μm, 1800-2000 μm, 2000-2300 μm and 2500 μm, and a polydispersity index of 1.01 to 1.03.

### EXAMPLE 39

The poly(vinyl pivalate) microspheres of (particle diameter of 50 to 1000 μm, polydispersity index of particle diameter of 1.80, number-average degree of polymerization of 40,000, and degree of branching of 2.3) prepared by suspension polymerization as in Example 3 were milled with a mortar and pestle using sodium chloride as a dispersing and antistatic agent in an amount of 0.5 g per 1.0 g of the poly(vinyl pivalate) microspheres, and separated using standard sieves. The separated microspheres were stirred with a magnetic stirrer in a 250 ml beaker, washed with 100 ml of distilled water for 4 hours, and filtered with a glass filter. After the residue was dried at 40° C. under a vacuum atmosphere for one day, microspheres bearing various sizes were obtained. The separated microspheres had size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400-450 μm, 450-500 μm, 500-600 μm, 600-700 μm, 700-800 μm, 800 μm, 900-1000 μm, 1000-1200 μm, 1200-1500 μm, 1500-1800 μm, 1800-2000 μm, 2000-2300 μm, and a polydispersity index of 1.03 to 1.06.

### EXAMPLE 40

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 90 to 100 μm, polydispersity index of 1.03, and number-average degree of polymerization of 24,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 38.5%, a particle diameter of 86 to 98 μm, and a polydispersity index of 1.04.

### EXAMPLE 41

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 200 to 220 μm, polydispersity index of 1.01, and number-average degree of polymerization of 24,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess, amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 16.0%, a particle diameter of 200 to 220 μm, and a polydispersity index of 1.02.

### EXAMPLE 42

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 410 to 430 μm, polydispersity index of 1.02, and number-average degree of polymerization of 47,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 14.5%, a particle diameter of 410 to 430 PA, and a polydispersity index of 1.02.

### EXAMPLE 43

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 300 to 350 μm, polydispersity index of 1.10, and number-average degree of polymerization of 43,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 28.5%, a particle diameter of 290 to 340 μm, and a polydispersity index of 1.12.

### EXAMPLE 44

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 100 to 120 μm, polydispersity index of 1.03, and number-average degree of polymerization of 32,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 45.0%, a particle diameter of 85 to 100 man, and a polydispersity index of 1.05.

### EXAMPLE 45

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 120 to 150 μm, polydispersity index of 1.03, and number-average degree of polymerization of 32,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 39.5%, a particle diameter of 115 to 145 μm, and a polydispersity index of 1.04.

### EXAMPLE 46

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 150 to 200 μm, polydispersity index of 1.03, and number-average degree of polymerization of 33,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 36.0%, a particle diameter of 147 to 200 μm, and a polydispersity index of 1.03.

### EXAMPLE 47

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 150 to 180 μm, polydispersity index of 1.02, and number-average degree of polymerization of 24,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 13.6%, a particle diameter of 150 to 180 μm, and a polydispersity index of 1.02.

### EXAMPLE 48

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 53 to 90 μm, polydispersity index of 1.10, and number-average degree of polymerization of 24,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 36.7%, a particle diameter of 50 to 90 Ar, and a polydispersity index of 1.09.

### EXAMPLE 49

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 53 to 75 μm, polydispersity index of 1.06, and number-average degree of polymerization of 24,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 14.1%, a particle diameter of 52 to 74 μm, and a polydispersity index of 1.05.

### EXAMPLE 50

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 75 to 90 μm, polydispersity index of 1.03, and number-average degree of polymerization of 24,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 27.3%, a particle diameter of 50 to 70 μm, and a polydispersity index of 1.04.

### EXAMPLE 51

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 180 to 200 μm, polydispersity index of 1.01, and number-average degree of polymerization of 24,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 89.0%, a particle diameter of 175 to 195 μm, and a polydispersity index of 1.02.

### EXAMPLE 52

In a 250 ml two-neck flask equipped with a thermometer and a cooling column, 100 ml of aqueous alkali solution where 8.75 g of potassium hydroxide, 8.75 g of sodium sulfite and 8 g of methanol are added to medium water. 0.5 g of poly(vinyl pivalate) microspheres (particle size of 210 to 230 μm, polydispersity index of 1.01, and number-average degree of polymerization of 24,000) prepared using sodium sulfite for the dispersing and antistatic agent as in Example 38 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 94.0%, a particle diameter of 200 to 220 μm, and a polydispersity index of 1.01.

### EXAMPLE 53

In a 250 ml two-neck flask equipped with a thermometer and a cooling column, 200 ml of aqueous alkali solution where 43.75 g of potassium hydroxide, 43.75 g of sodium sulfate and 40 g of methanol are added to medium water. 0.5 g of poly(vinyl pivalate) microspheres (particle size of 200 to 220 an, polydispersity index of 1.01, and number-average degree of polymerization of 30,000) prepared using sodium sulfate for the dispersing and antistatic agent as in Example 37 were suspended in the aqueous alkali solution, and saponified at 30° C. for 8 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 96.4%, a particle diameter of 190 to 210 μm, and a polydispersity index of 1.06.

### EXAMPLE 54

In a 250 ml two-neck flask equipped with a thermometer and a cooling column, 200 ml of aqueous alkali solution where 43.75 g of potassium hydroxide, 43.75 g of sodium sulfate and 40 g of methanol are added to medium water. 0.5 g of poly(vinyl pivalate) microspheres (particle size of 200 to 220 μm, polydispersity index of 1.01, and number-average degree of polymerization of 30,000) prepared using sodium sulfate for the dispersing and antistatic agent as in Example 37 were suspended in the aqueous alkali solution, and saponified at 5° C. for 24 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 8.0%, a particle diameter of 210 to 220 μm, and a polydispersity index of 1.02.

### EXAMPLE 55

In a 250 ml two-neck flask equipped with a thermometer and a cooling column, 100 ml of aqueous alkali solution where 8.75 g of potassium hydroxide, 8.75 g of sodium sulfate and 8 g of methanol are added to medium water. 0.5 g of poly(vinyl pivalate) microspheres (particle size of 90 to 100 μm, polydispersity index of 1.03, and number-average degree of polymerization of 24,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 23.4%, a particle diameter of 87 to 95 μm, and a polydispersity index of 1.04.

### EXAMPLE 56

In a 250 ml two-neck flask equipped with a thermometer and a cooling column, 100 ml of aqueous alkali solution where 8.75 g of sodium hydroxide, 8.75 g of sodium sulfate and 8 g of methanol are added to medium water. 0.5 g of poly(vinyl pivalate) microspheres (particle size of 200 to 220 u, polydispersity index of 1.01, and number-average degree of polymerization of 24,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 12.4%, a particle diameter of 200 to 220 μm, and a polydispersity index of 1.02.

### EXAMPLE 57

In a 250 ml two-neck flask equipped with a thermometer and a cooling column, 100 ml of aqueous alkali solution where 8.75 g of sodium hydroxide, 8.75 g of sodium sulfate and 8 g of methanol are added to medium water. 0.5 g of poly(vinyl pivalate) microspheres (particle size of 410 to 430 μm, polydispersity index of 1.02, and number-average degree of polymerization of 47,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 9.6%, a particle diameter of 410 to 430 μm, and a polydispersity index of 1.02.

### EXAMPLE 58

In a 250 ml two-neck flask equipped with a thermometer and a cooling column, 100 ml of aqueous alkali solution where 8.75 g of sodium hydroxide, 8.75 g of sodium sulfate and 8 g of methanol are added to medium water. 0.5 g of poly(vinyl pivalate) microspheres (particle size of 300 to 350 μm, polydispersity index of 1.10, and number-average degree of polymerization of 43,000) prepared using sodium sulfate for the dispersing and antistatic agent as in Example 37 were suspended in the aqueous alkali solution, and saponified at 40° C. for 4 hours while being stirred with a magnetic stirrer. After the saponification reaction had been completed, the reacted material was poured into chilled distilled water, stirred for one hour, and filtered with a glass filter. The residue was washed with an excess amount of distilled water, and filtered. This process was repeated three times. The residue was dried at 40° C. under a vacuum atmosphere for one day, thereby obtaining poly(vinyl pivalate) microspheres where only the surface thereof was saponified to PVA. The PVA (skin)/poly(vinyl pivalate) (core) microspheres had a degree of saponification of 19.2%, a particle diameter of 290 to 340 μm, and a polydispersity index of 1.12.

### COMPARATIVE EXAMPLE 1

In a 200 ml four-neck flask equipped with a thermometer, a nitrogen inlet, a cooling column and an anchor-type stirrer, vinyl pivalate monomer and 14.2 g (0.2 mol) of dimethysulfoxide were charged, and mixed. Nitrogen, which passed a trap of pyrogallol-alkali solution and a trap of CaCl₂ to remove its oxygen and moisture content from, was forcefully passed through the mixture for two hours to thereby remove the oxygen and moisture content from the mixture. The temperature in the flask was elevated to 30° C., and then, 0.0033 g (4.0×10⁻⁵ μm, and precipitated in methanol. The polymerized material was dissolved in benzene, and precipitated in methanol. After this process was so repeated several times while removing the remaining monomers, the resulting precipitates were dried at 60° C. under the vacuum atmosphere for one day, thereby obtaining white resinous poly(vinyl pivalate).

### COMPARATIVE EXAMPLE 2

In a 200 ml four-neck flask equipped with a thermometer, a nitrogen inlet, a cooling column and an anchor-type stirrer, vinyl pivalate monomer was charged, and stirred. Nitrogen, which passed a trap of pyrogallol-alkali solution and a trap of CaCl₂ to remove its oxygen and moisture content, was forcefully passed through the vinyl pivalate for two hours to thereby remove the oxygen and moisture content from the vinyl pivalate. The temperature in the flask was elevated to 30° C., and then, 0.0033 g (4.0×10⁻⁵ μm, and precipitated in methanol. The polymerized material was dissolved in benzene, and precipitated in methanol. After this process was repeated several times while removing the remaining monomers, the resulting precipitates were dried at 60° C. under the vacuum atmosphere for one day, thereby obtain white resinous poly(vinyl pivalate).

### COMPARATIVE EXAMPLE 3

In a 250 ml four-neck flask equipped with a thermometer, a nitrogen inlet, a cooling column, and an anchor-type stirrer, 100 ml (5.5 mol) of distilled water and 1.5 g of PVA (1.18×10-5 μm, degree of saponification of 88%, and number-average molecular weight of 127,000) for a suspending agent were charged, and mixed at 50° C. The mixture was then cooled at ambient temperature. Nitrogen, which passed a trap of pyrogallol-alkali solution and a trap of CaCl₂ to remove its oxygen and moisture content, was forcefully passed through the mixture for two hours to thereby remove the oxygen and moisture content from the mixture. 79.5 ml (0.54 mol/mol of monomer) of vinyl pivalate monomer and 0.0266 g (3.0×10⁻⁴ mol/mol of monomer) of azobisdimethylvaleronitrile initiator were added to the mixture, and the oxygen and moisture content was removed from the mixture for one hour. The temperature in the flask was elevated to 80° C., and the vinyl pivalate monomer was polymerized through stirring at 300 rpm under a nitrogen stream for two hours. Chilled distilled water was poured into the produced polymer-including suspension while precipitating the polymer content from the suspension, and it was filtered with a glass filter. The residue was washed with distilled water, and again filtered. This process was repeated several times while removing the remaining monomers and the suspending agent. The resulting residue was dried at 40° C. under the vacuum atmosphere for one day, thereby obtaining poly(vinyl pivalate) microspheres with a particle diameter of 15 to 70 μm, and a polydispersity index of 1.52.

The analysis results (conversion rate, number-average degree of polymerization, syndiotactic diad content, and degree of branching) with respect to the materials according to Examples 1 to 33 and Comparative

Examples 1 to 3 are listed in Table 1.

TABLE 1

| | | Suspending | | | | | | | |
|---|---|---|---|---|---|---|---|---|---|
| | Initiator | agent | | | | | Number- | | |
| | (×10⁻⁴ | (×10⁻⁶ | Poly. | Poly. | Stirring | Conver- | average | Syndiotactic | |
| | mol/mol of | mol/mol of | temp. | time | speed | sion rate | degree of | diad content | Degree of |
| | monomer) | momomer) | (° C.) | (hour) | (rpm) | (%) | poly. | (%) | branching |
| Ex. 1 | 2 | 7.09 | 50 | 24 | 300 | 95 | 35000 | 58.9 | 2.4 |
| Ex. 2 | 1 | 7.09 | 50 | 24 | 300 | 94 | 40000 | 59.0 | 2.4 |
| Ex. 3 | 0.3 | 7.09 | 50 | 24 | 300 | 91 | 40000 | 59.1 | 2.3 |
| Ex. 4 | 0.2 | 7.09 | 50 | 24 | 300 | 69 | 40000 | 59.4 | 2.2 |
| Ex. 5 | 0.1 | 7.09 | 50 | 24 | 300 | 76 | 43000 | 59.3 | 2.2 |
| Ex. 6 | 2 | 7.09 | 40 | 36 | 300 | 91 | 36000 | 60.4 | 1.9 |
| Ex. 7 | 1 | 7.09 | 40 | 36 | 300 | 88 | 38000 | 60.6 | 1.8 |
| Ex. 8 | 0.3 | 7.09 | 40 | 36 | 300 | 84 | 44000 | 60.9 | 1.8 |
| Ex. 9 | 2 | 7.09 | 30 | 52 | 300 | 85 | 33000 | 61.5 | 1.4 |
| Ex. 10 | 1 | 7.09 | 30 | 52 | 300 | 83 | 30000 | 61.7 | 1.1 |
| Ex. 11 | 0.3 | 7.09 | 30 | 52 | 300 | 79 | 32000 | 61.7 | 0.9 |
| Ex. 12 | 2 | 21.3 | 50 | 24 | 300 | 95 | 36000 | 58.9 | 2.4 |
| Ex. 13 | 0.3 | 21.3 | 50 | 24 | 300 | 92 | 40000 | 59.0 | 2.3 |
| Ex. 14 | 0.1 | 21.3 | 50 | 24 | 300 | 76 | 47000 | 59.1 | 2.3 |
| Ex. 15 | 2 | 21.3 | 40 | 36 | 300 | 91 | 35000 | 60.3 | 1.8 |
| Ex. 16 | 0.3 | 21.3 | 40 | 36 | 300 | 85 | 44000 | 61.0 | 1.8 |
| Ex. 17 | 2 | 21.3 | 30 | 52 | 300 | 85 | 24000 | 61.4 | 1.1 |
| Ex. 18 | 0.3 | 21.3 | 30 | 52 | 300 | 80 | 31000 | 61.7 | 0.9 |
| Ex. 19 | 2 | 2.36 | 50 | 24 | 300 | 93 | 36000 | 58.9 | 2.5 |
| Ex. 20 | 0.3 | 2.36 | 50 | 24 | 300 | 90 | 41000 | 59.0 | 2.3 |
| Ex. 21 | 0.1 | 2.36 | 50 | 24 | 300 | 77 | 45000 | 59.1 | 2.3 |
| Ex. 22 | 2 | 2.36 | 40 | 36 | 300 | 91 | 36000 | 60.4 | 1.6 |
| Ex. 23 | 0.3 | 2.36 | 40 | 36 | 300 | 84 | 44000 | 60.8 | 1.5 |
| Ex. 24 | 2 | 2.36 | 30 | 52 | 300 | 86 | 31000 | 61.5 | 1.3 |
| Ex. 25 | 0.3 | 2.36 | 30 | 52 | 300 | 79 | 33000 | 61.6 | 1.0 |
| Ex. 26 | 0.3 | 7.09 | 30 | 52 | 100 | 75 | 46000 | 60.8 | 2.5 |
| Ex. 27 | 0.3 | 7.09 | 30 | 52 | 500 | 81 | 38000 | 60.9 | 2.2 |
| Ex. 28 | 0.3 | 7.09 | 30 | 52 | 1000 | 82 | 39000 | 60.8 | 2.2 |
| Ex. 29 | 0.3 | 7.09 | 30 | 52 | 2000 | 83 | 37000 | 60.9 | 2.1 |
| Ex. 30 | 0.3 | 7.09 | 30 | 52 | 3000 | 83 | 35000 | 61.0 | 2.0 |
| Ex. 31 | 0.3 | 7.09 | 25 | 60 | 2000 | 69 | 35000 | 61.9 | 2.0 |
| Ex. 32 | 2 | 7.09 | 50 | 12 | 300 | 80 | 31000 | 59.3 | 2.0 |
| Ex. 33 | 2 | 7.09 | 50 | 18 | 300 | 94 | 34000 | 58.9 | 2.3 |
| Comp. Ex. 1 | 0.4 | 0.2 (DMSO) | 30 | 11 | 300 | 32 | 33000 | 60.8 | 1.0 |
| Comp. Ex. 2 | 0.4 | − | 30 | 6 | 300 | 11 | 31000 | 61.1 | 0.9 |
| Comp. Ex. 3 | 3 | 11.8 | 80 | 2 | 300 | 48 | 14000 | 57.1 | 4.3 |

(Note:
In Table 1, “Poly.” refers to the “polymerization”)

It can be known from Table 1 that with Examples, high molecular weight poly(vinyl pivalate) microspheres of a uniform size distribution having a maximum conversion rate of 95%, a number-average degree of polymerization of 24,000 to 47,000, and a syndiotactic diad content of 58.9 to 61.9% can be obtained through the low temperature suspension polymerization at 20 to 70° C.

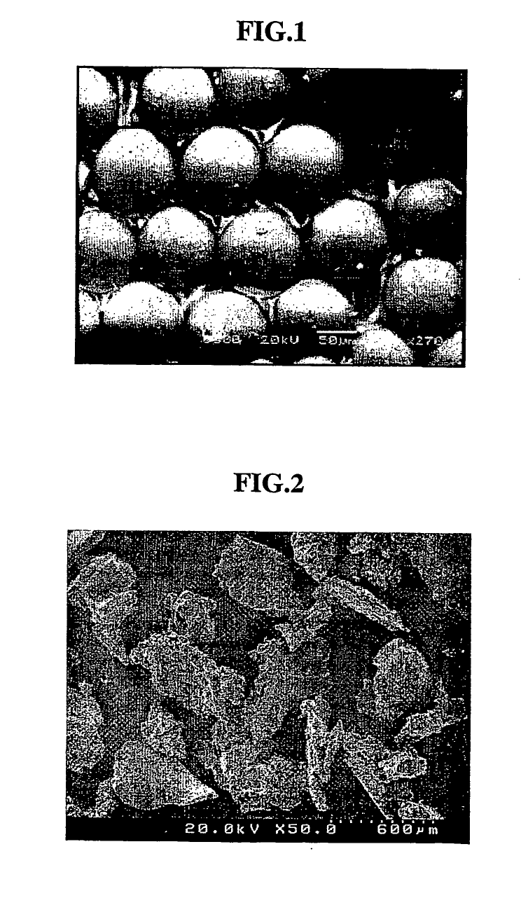

Embolic particles with an outer PVA skin and an inner poly(vinyl pivalate) core prepared through the inhomogeneous surface saponification of the poly(vinyl pivalate) microspheres were photographed by way of SEM. Among them, the SEM photograph of the PVA embolic particles prepared according to Example 46 is shown in FIG. 1. For comparison, a SEM photograph of the PVA prepared by general homogeneous saponification of poly(vinyl pivalate) according to Comparative Example 2 is shown in FIG. 2. It can be confirmed from FIG. 1 that the PVA particles of Example 46 have a completely spherical shape while having a uniform size distribution. On the contrary, the PVA of FIG. 2 has a very rough and sharp surface while having a non-uniform size distribution.

As described above, vinyl pivalate is suspension-polymerized at 20 to 70° C. to thereby obtain poly(vinyl pivalate) microspheres of uniform size distribution with a high molecular weight and a high syndiotacticity. The poly(vinyl pivalate) microspheres involve a high conversion rate of 50% or more, a number-average degree of polymerization of 300 to 50,000, a syndiotactic diad content of 54 to 65%, and a degree of branching of 0.2 to 6.0 with respect to the pivalate group. The poly(vinyl pivalate) microspheres are separated using a dispersing and antistatic agent to thereby obtain microspherical poly(vinyl pivalate) microspheres where the particle sizes are uniformly distributed in the range of 1 to 3000 μm, the difference between upper and lower limits of the particle diameters is in the range of about 1 μm to about 500 μm, and the polydispersity index of particle diameter is in the range of 1.00 to 1.60. The separated poly(vinyl pivalate) microspheres are surface-saponified using an aqueous alkali solution to thereby obtain spherical embolic particles with a dual structure of an outer PVA skin and an inner poly(vinyl pivalate) core where the shape and size of the poly(vinyl pivalate) microspheres are maintained without deformation. The spherical embolic particles have a polydispersity index of 1.00 to 1.20, and a degree of saponification of 1 to 99.9%.

As the spherical embolic particles involve a smooth surface and a uniform size distribution, they can be effectively used as an embolic material for embolotherapy. In embolotherapy, the blood flow in blood supply vessels for lesions at surgically untreatable sites is blocked through injecting the embolic material into the blood vessels, thereby treating the lesions, relieving symptoms due to excessive blood flow, and preventing hemorrhaging during surgical operations. For instance, the embolotherapy based on the embolic material of the present invention may be used for treatment for hypervascular tumors with high vascularity, vascular diseases such as arteriovenous malformation (AVM), and traumatic or inflammatory hemorrhaging as with tuberculosis.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A method of preparing poly(vinyl pivalate) microspheres having a high syndiotacticity and a high molecular weight,
wherein the method comprises suspension polymerization of vinyl pivalate at low temperatures, a suspension comprising vinyl pivalate, azobisdimethylvaleronitrile as an initiator, a suspending agent, and water is stirred at 20 to 70° C. with a stirring speed of 10 to 5000 rpm, and the suspension has a composition of per 1 mol of the vinyl pivalate 1×10⁻⁵ mol to 5×10⁻³ μm, 1×10⁻⁴ mol to 1×10⁻⁴ mol of the suspending agent, and 1.0 mol to 50 mol of water.

2. The method of claim 1 wherein the polymerization temperature ranges from 20° C. to 50° C.

3. The method of claim 1 wherein the suspending agent is at least one selected from the group consisting of poly(vinyl alcohol) (PVA), arabic gum, hydroxyethyl cellulose, methyl cellulose, starch, sodium polyacrylate, sodium polymethacrylate, gelatine, styrene-maleic anhydride copolymer neutralized with sodium hydroxide or aqueous ammonia and mixtures thereof.

4. The method of claim 1 wherein the suspending agent is PVA that is partially or completely saponified.

5. The method of claim 1 wherein the suspension polymerization is performed in a mixer equipped with a thermometer, a nitrogen inlet, a cooling column and an anchor-type stirrer, comprising:
mixing water and a suspending agent at 30 to 70° C.;
cooling the mixture at ambient temperature;
removing the oxygen and moisture content from the mixture by forcefully passing nitrogen, with the oxygen and moisture content removed by passing it through a trap of pyrogallol-alkali solution and a trap of CaCl₂, therethrough;
adding vinyl pivalate monomer and azobisdimethylvaleronitrile initiator to the mixture, elevating the temperature in the mixer to 20 to 70° C.; and
subjecting the vinyl pivalate monomer to suspension polymerization under the nitrogen stream.

6. Poly(vinyl pivalate) microspheres prepared according to the method of claim 1 with a conversion rate from monomer to polymer of 50% or more, the poly(vinyl pivalate) microspheres having a number-average degree of polymerization of 300 to 50,000, a syndiotactic diad content of 54 to 65%, and a degree of branching of 0.2 to 6.0 with respect to the pivalate group.

7. A method of preparing poly(vinyl pivalate) microspheres having uniform particle diameters ranging from 1 μm to 3000 μm, where a difference between upper and lower limits of the particle diameters ranges from about 1 μm to about 500 μm and a polydispersity index of particle diameter ranging from 1.00 to 1.60, the method comprising:
adding an inorganic salt as a dispersing and antistatic agent to poly(vinyl pivalate) microspheres;
milling the associated poly(vinyl pivalate) microspheres; and
separating the poly(vinyl pivalate) microspheres using standard sieves to obtain the uniform sized poly(vinyl pivalate) microspheres.

8. The method of claim 7 wherein the amount of the inorganic salt is established to be 0.1 to 100 g per 1 g of the poly(vinyl pivalate) microspheres.

9. The method of claim 7 wherein the poly(vinyl pivalate) microspheres have size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400 μm, 450-500 μm, 500-600 μm, 600-700 μm, 700-800 μm, 800-900 μm, 900-1000 μm, 1000-1200 μm, 1200-1500 μm, 1500-1800 μm, 1800-2000 μm, 2000-2300 μm, or 2500-3000 μm.

10. The method of claim 7 wherein the inorganic salt is at least one selected from the group consisting of alkali metal salts, alkali earth metal salts, and mixtures thereof.

11. The method of claim 7 wherein the inorganic salt for the dispersing and antistatic agent is at least one selected from the group consisting of sodium sulfate (Na₂SO₄), sodium sulfite (Na₂SO₃), sodium chloride (NaCl), calcium sulfate (CaSO₄), magnesium sulfate (MgSO₄), and mixtures thereof.

12. Poly(vinyl pivalate) microspheres prepared according to the method of claim 7, poly(vinyl pivalate) microspheres having uniform particle diameters ranging from 1 μm to 3000 μm, where a difference between upper and lower limits of the particle diameters ranges from about 1 an to about 500 μm, and a polydispersity index of particle diameter ranging from 1.00 to 1.60.

13. A method of preparing embolic particles having a dual structure of an outer PVA skin and an inner poly(vinyl pivalate) core, the method comprising:
suspending poly(vinyl pivalate) microspheres prepared according to the method of claim 7 in an aqueous alkali solution containing at least one salt selected from the group consisting of sulfates, sulfites and mixtures thereof; hydroxides; alcohols for an inflating agent; and water; and
saponifying only the surface of the poly(vinyl pivalate) microspheres.

14. The method of claim 13 wherein the amount of the sulfates or sulfites is 0.1 to 100 g per 1 g of the poly(vinyl pivalate) microspheres, the amount of the hydroxides is 0.1 to 100 g per 1 g of the poly(vinyl pivalate) microspheres, and the amount of the alcohols is 0.1 to 100 g per 1 g of the poly(vinyl pivalate) microspheres.

15. The method of claim 13 wherein the amount of the aqueous alkali solution is established to be 10 to 1000 ml per 1 g of the poly(vinyl pivalate) and mixtures thereof.

16. The method of claim 13 wherein the alcohols are at least one selected from the group consisting of methanol, ethanol, isopropanol, and mixtures thereof.

17. Embolic particles having a dual structure of an outer PVA skin and an inner poly(vinyl pivalate) core where a degree of saponification of the poly(vinyl pivalate) is in the range of 1 to 99.9%, the embolic particles having uniform particle diameters ranging from 1 μm to 3000 μm, where a difference between upper and lower limits of the particle diameters ranges from about 1 μm to about 500 μm, and a polydispersity index of particle diameter ranges from 1.00 to 1.20.

18. The embolic particles of claim 17 having particle size distributions of 1-5 μm, 5-10 μm, 10-30 μm, 30-50 μm, 50-70 μm, 70-90 μm, 90-100 μm, 100-120 μm, 120-150 μm, 150-180 μm, 180-200 μm, 200-220 μm, 220-250 μm, 250-300 μm, 300-350 μm, 350-400 μm, 400-450 μm, 450-500 μm, 500 μm, 600-700 μm, 700-800 μm, 800-900 μm, 900-1000 μm, 1000-1200 μm, 1200-1500 μm, 1500-1800 μm, 1800-2000 μm, 2000-2300 μm, or 2500-3000 μm.

19. The embolic particles of claim 18 wherein the ratio of the outer diameter of PVA to the inner diameter of poly(vinyl pivalate) is in the range of 1:0.01 to 0.99.
